(19) United States
(12) Patent Application Publication
(10) Pub. No.: US 2025/0205924 A1
(43) Pub. Date: Jun. 26, 2025

(54) RIGID COLORED MATERIAL FOR CONSTRUCTION AND FURNITURE

(71) Applicants: Armand BERNOUD, Paris (FR); Romée GUIGNARD DE LA BIGNE, Paris (FR); Basile DE GAULLE, Paris (FR); MAXIMUM SAS, IVRY-SUR-SEINE (FR)

(72) Inventors: Armand BERNOUD, Paris (FR); Romée GUIGNARD DE LA BIGNE, Paris (FR); Basile DE GAULLE, Paris (FR)

(21) Appl. No.: 18/851,038

(22) PCT Filed: Mar. 23, 2023
(86) PCT No.: PCT/EP2023/057574

§ 371 Date: Sep. 25, 2024

(30) Foreign Application Priority Data
Mar. 25, 2022 (FR) FR2202713

(51) Int. Cl. B27N 3/04; B27N 1/00; B27N 3/00; B27N 3/18; B27N 3/20

(52) U.S. Cl. CPC B27N 3/04; B27N 1/00; B27N 3/002; B27N 3/007; B27N 3/18; B27N 3/203

(57) ABSTRACT

The invention consists of a rigid material 1 for construction or furniture, comprising fibrous particles bonded together by a binder, and its method of manufacture. The fibrous particles are textile fibers, and the binder belongs to the family of thermoplastic or thermosetting materials such as epoxy resins. The proportion of binder in the total weight is between 10% and 50%. The rigid material can be produced in the form of panels 2 or furniture components.

### TECHNICAL SCOPE OF THE INVENTION

The invention relates generally to the technical field of rigid particle materials, such as medium, intended for obtaining rigid flat panels with predefined dimensions, or for producing furniture components such as chair backs or seats.

The invention relates more specifically to a rigid and colored material with a low or negative environmental impact obtained from recycled components and to its manufacturing process.

### PRIOR ART

Panels made from wood fiber are commonly used in construction and furniture manufacture. Among the best-known wood fiber panels, MDF (Medium Density Fiberboard) is highly valued for its strength, low cost and versatility of use.

The medium is obtained from common wood particles that have undergone steam defibration. After defibration, the wood fibers are agglomerated with a urea-formaldehyde or melamine-formaldehyde binder, and the resulting mixture is thermopressed to form panels that are cut to various standard sizes. Despite its many advantages, medium can be harmful to the health of those who work with it, as it contains formaldehyde.

In addition, as raw materials become increasingly scarce, there is a growing need to produce materials from recycled sources. There is therefore an environmental and economic need for a rigid, healthy material that can be used for both construction and furnitures obtained from materials to be recycled. Since the European Parliament's approval of the Waste Directive in 2018, this need has become a legal obligation, since by 2025 EU countries will have to collect textiles separately.

Patent application WO98/36114 describes an insulating felt made from textile fibers and an epoxy binder, which may be in powder form.

### EXPLANATION OF THE INVENTION

The aim of the present invention is to remedy all or some of the disadvantages of the state of the art and to meet the environmental and economic need indicated above, in particular by offering a sound rigid material with properties similar to those of the medium and obtained from materials from the recycling of used clothing and paint powders to be landfilled or incinerated.

To this end, according to a first aspect of the invention, a rigid material for construction or furniture is proposed comprising fibrous particles bonded together by a binder belonging to the family of thermoplastic or thermosetting materials such as powdered epoxy resins, in which the fibrous particles are textile fibers and the binder is composed of paint powder from unheated paint waste. The proportion of binder in the total weight is between 10% and 50%. It is preferably 20%, 30% or 40%.

Preferably, the textile fibers are obtained by fraying textile pieces, at least some of which come from used clothing.

Advantageously, the textile fibers comprise a mixture of natural and synthetic textile fibers such as cotton or polyester fibers, and/or the rigid material is colored throughout by the color of the textile fibers used.

Preferably, the paint powders used as binder are mainly composed of epoxy, polyester, polyurethane or acrylics, and/or the paint powders used as binder comprise paint, primer or varnish powders, or a mixture of these powders.

Advantageously, the rigid material also comprises at least one additive such as an antifungal agent, a water repellent and/or a flame retardant.

Preferably, the rigid material is obtained by thermopressing the textile fibers and the binder, and/or its final thickness is obtained by sanding, calendering or cold pressing.

According to a second aspect of the invention, a process is proposed for manufacturing a rigid material for construction or furniture, comprising a step of collecting paint powders in paint booths to obtain a thermoplastic or thermosetting powder binder, a step of mixing a thermoplastic or thermosetting powder binder with textile fibres in a proportion of binder of between 20 and 30% of the total weight, a step of spreading the textile fibres mixed with the binder to form a mat; and a step of hot-pressing said mat at a temperature depending on the nature of the binder, in which, preferably, after hot-pressing the material undergoes a cooling step while maintaining the pressure.

Advantageously, the process also comprises, for the preparation of the textile fibres, a step for sorting the colours of the textile parts to be recycled, a sorting step to remove non-fraying textiles, a delissage step, a defibration step by mechanical fraying of the sorted textile parts, and/or a step for separating the textile fibres by blowing.

Preferably, the manufacturing process also includes a step of collecting non-reusable used clothing to obtain at least some of the said textile fibres, or other pieces of textile to be recycled.

Advantageously, the manufacturing process also includes a step of spraying at least one additive, and/or a step of calendering and/or sanding after the hot pressing or cooling step.

Preferably, the process further comprises a step of cutting said rigid material into panels of the required dimensions, or that the hot pressing step is carried out in a mould to form furniture components.

Advantageously, hot pressing is carried out at a temperature of between 160° C. and 200° C., for example 180° C., for a period of between 6 and 10 minutes, for example 8 minutes, and/or at a pressure of between 10 kg/cm2 and 40 kg/cm2, for example 20 or 30 kg/cm2; and/or the step of mixing the powdered binder with the textile fibres is carried out while hot.

Other features and advantages of the invention are highlighted by the following description of non-limiting examples of the various aspects of the invention.

### BRIEF DESCRIPTION OF THE FIGURES

This description refers to the attached figures, which are also given as non-limiting examples of the invention:

FIG. 1 shows a panel obtained using the material of the invention;

FIG. 2 shows a chair made from the material of the invention;

FIG. 3 shows the different states of the material of the invention during its manufacture;

FIG. 4 illustrates the process for preparing textile fibers intended for making the material of the invention;

FIG. 5 illustrates the process for preparing the paint powder used as a binder for the textile fibers; and

FIG. 6 illustrates the process for manufacturing a sheet of material according to the invention.

For greater clarity, identical or similar elements are identified by identical reference signs throughout the figures.

### DETAILED DESCRIPTION OF AN EMBODIMENT

In Europe 5.8 million tonnes of textile waste are thrown away every year, of which only 1.5 million tonnes are sorted for recycling. In France in 2019, 196,054 tonnes of textiles and footwear were sorted by operators in the used clothing recycling sector. In 2020, this volume was 156,202 tonnes, representing a 20% drop in collections, mainly due to the COVID 19 pandemic. 56.5% of the used clothing collected and sorted is destined for reuse as second-hand clothing. A further 33.3% of this textile is exported to low labour cost countries to be recycled for other non-clothing industrial uses, and 9.1% is recycled to produce fuel for French cement works. In addition, there is a potential for currently uncollected textiles representing 400,000 tonnes in France and up to 5,000,000 tonnes at European level, which can be mobilised if new industrial recycling outlets are implemented. The invention uses the considerable volume represented by this textile to be recycled to produce a rigid material based on recycled textile fibers suitable for use in place of the medium. The manufacture of the material described below from this mass of non-reusable textile available at low cost meets the environmental need, especially as the textile material which will no longer be exported will reduce the current carbon footprint of the textile recycling industry, and the constraints of industrialising a production process for such a material.

The other main component of the rigid material described below is the binder which will enable the textile fibers to be agglomerated to form panels or furniture components with mechanical and operational characteristics similar to those of the medium. The epoxy powder lost in electrostatic paint booths is used as the binder for the manufacture of this rigid material.

Epoxy powders are increasingly used for surface coating, thanks to their physical and chemical properties. Paint powders are made up of 4 main components: a paint binder, pigments, fillers and various additives. The paint binder is the main component of paint powders. It provides the link between all the paint components and ensures the paint adheres to the surface to be painted. The paint binder comes in powder form and can be based on epoxy resin (also known as epoxy), epoxy-polyester, polyester resin cured with triglycidyl isocyanurate, acrylic-urethane or polyester-urethane. Although in the remainder of the description reference is made to epoxy as a binder, any of the binders used in paint powders can be used to make the rigid material of the invention, such as those indicated above.

In powder coating processes, the epoxy powder is applied electrostatically: the powder is electrostatically sprayed onto a part to be coated, usually a metal part, using an electrostatic gun. The plastic is then melted onto the part, which is then dried in an oven or under UV light. Powder coating is carried out in a spray booth designed specifically for this purpose. These spray booths have an integrated powder vacuum recovery system that collects the particles that escape the electrostatic attraction of the surface to be painted during spraying, enabling them to be recycled. Waste from the epoxy spraying process, which represents 40% of the powder sprayed during the painting process, ends up on the floor of the booth and in the filters of the suction system, mainly in the form of powder (60% of the spray waste collected). This waste powder that can be recovered cannot be reused for painting, as it is a mixture of different products sprayed, such as paints of different pigmentations, primers or varnishes. However, the recovered powder can be used as a binder to make the rigid material described below.

In addition to its mechanical properties, which make it a highly sought-after product in industry, the main advantage of epoxy powders is that, unlike liquid paints, they contain no solvents. As a result, this surface coating process does not release any VOCs (Volatile Organic Compounds), and once applied is very healthy for users. However, it does generate a lot of hazardous waste that is not currently recycled in the industry, so it has to be incinerated or worse, buried to get rid of it. The quantity of used epoxy powder is estimated at 27,000 tonnes a year in France, and ten times more in Europe. The development of recycling facilities for this hazardous industrial waste, as proposed here, is therefore a major environmental challenge. The cost of processing epoxy waste is €400 per tonne for the producer, making it a negative-cost material for those who can reuse it.

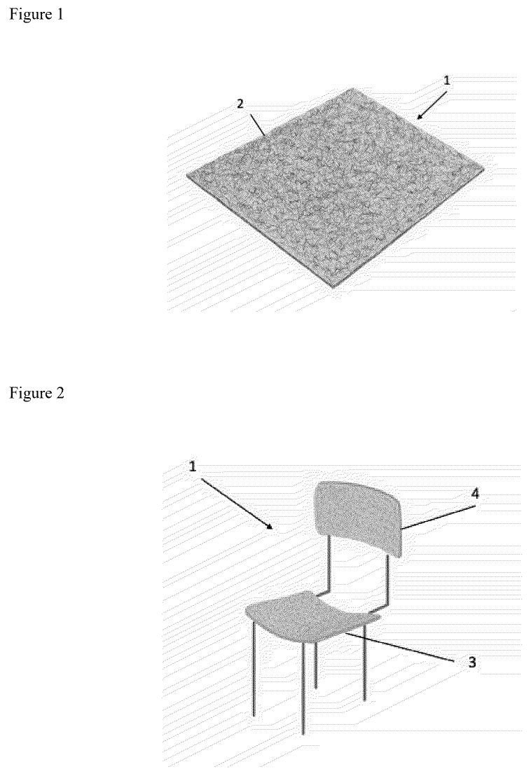

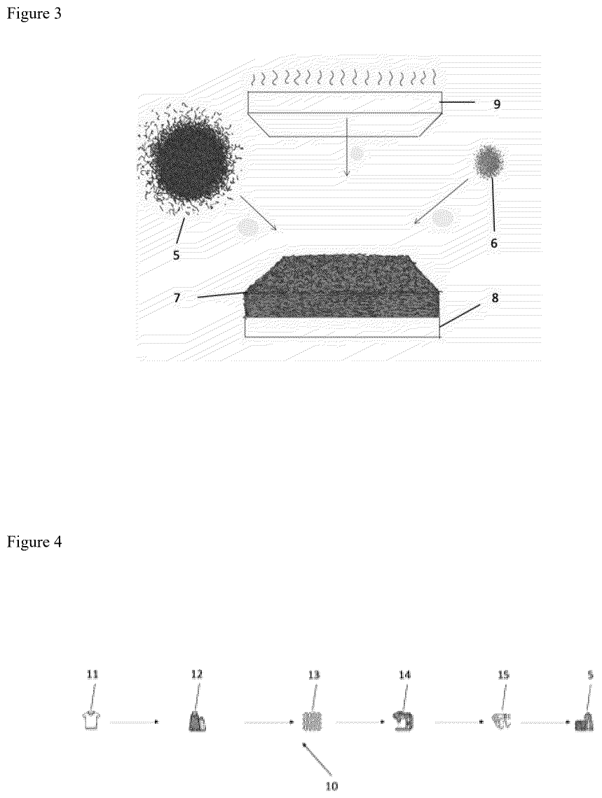

The invention relates to a rigid material 1 which as shown in FIG. 3 [FIG. 3] is composed mainly, but not solely of textile fibers 5 which may be derived from used clothing, unused textiles (e.g. production off-cuts, end-of-series, or unsold stock), or a mixture of both. The rigid material 1 of the invention also comprises a powder binder 6 derived from paint powder wastage as explained above. The textile fibers 5 and the powder binder 6 are mixed to form a mat 7, the mat 7 comprising a proportion by weight of textile fibers 5 of between 60% and 80%, preferably 70%, and of powder binder 6 of between 10% and 50%, preferably 20%, 30% or 40%. As indicated in the introduction to this description, this rigid material 1 is intended mainly, but not exclusively, for construction, for example in the form of panels 2 cut to predefined dimensions (such as those of commercially available medium panels) as shown in FIG. 1 [FIG. 1], and for furniture such as a chair seat 3 or a chair back 4 shown in FIG. 2 [FIG. 2]. It can be used for other purposes such as all those of the medium to which it is similar in terms of its mechanical characteristics and processing methods. Rigid material 1 is the first particleboard with a low (or even negative) environmental impact. Panels 2 of rigid material 1 are available in different thicknesses, for example 6, 10, 16, 19, 22, 25, 30 or 40 mm, and in different widths and lengths, such as 1220×2440, 2070×2800,2070×3700 mm. It is also a healthy material, as the inertness of the epoxy gives the material an A+ rating on VOC measurements once manufactured. Rigid material 1 has a flexural strength of 25.68 MPa and a tensile strength of 28.94 MPa for standardised test samples with a cross-section of 10×3 mm and a length of 100 mm.

The density of the rigid material 1 used to make panels 2 or furniture components 3 and 4 is between 700 kg/m³ and 1000 kg/m³, preferably 850 kg/m3.

The composition of the used garments from which all or some of the textile fibers 5 used may come is perfectly faithful to what is present on the market, i.e. a mixture of natural and synthetic textile fibers, for example cotton and polyester fibers, since the nature of the fiber makes no difference to the mechanical properties of the material and the other fibers present on the market are in too small proportions to influence the properties. In this way, the usable used clothing collected does not need to be sorted according to its composition, which is a major economic advantage and also an environmental advantage, as the usable clothing forms part of the “all waste” at the end of the sorting line. However, the manufacture of the rigid material 1 requires the use of garments that can be frayed, so no leggings, oilskins, etc. are used. As will be described below, the fraying required for the production of rigid material 1 is conventional, end-of-line fraying, which can accommodate the small residual amount of hard points and metal objects contained in the frayed material. Sorting to remove the non-frailable material is carried out almost systematically by sorting and collection centres for used clothing.

The rigid material 1 can be obtained in different shades if the garments used to produce the textile fibers 5 undergo color sorting. Unlike material sorting, color sorting is simple to perform. Color sorting allows the rigid material 1 to be naturally dyed in its mass by using textile fibers 5 from used garments of the same color, which provides aesthetic added value through a controlled range of colors and avoids the need for surface treatment or finishing and thus the use of polluting additives. If color sorting is not desired, the rigid material 1 has a heterogeneous color resulting from the color mixing of the textile fibers 5 used. In addition to the unique aesthetic appearance obtained, the absence of color sorting can make it possible to offer a less expensive rigid material 1.

As described above, the powder binder 6 used to manufacture the rigid material 1 also comes from a waste product to be recycled. When an object is painted using powder paint, i.e. by applying a heat-enamelling powder to a mainly metallic object, a large proportion of the sprayed powder is not captured by the part. This lost paint powder ends up on the floor of the paint booth or is captured by the suction of the paint booths. These lost paint powders collected in the paint booths are mainly composed of epoxy and polyester, and more rarely polyurethane. As they have not undergone any heating process, they are perfectly usable except for painting, as they present a mixture of colour and nature between primers, paints and varnishes. Although of varied nature and mixed colours, the main composition of these paint powders makes it possible to obtain a polymer with sufficient mechanical properties to be used as a binder 6 in rigid materials 1. This new outlet for these toxic paint powders makes it possible to reduce or avoid their incineration or worse their burial.

As indicated above and illustrated in FIG. 3 [FIG. 3], the rigid material 1 is obtained by mixing powdered binder 6 and textile fibers 5 to form a mat 7 arranged in a mould 8 or a continuous conveyor belt. This mat 7 is then hot-pressed by a thermopressing device 8, which may be a mould upper part 9. The proportion of binder powder in the mixture obtained is between 10% and 50% of the weight of the mixture, preferably 20%, 30% or 40%. The proportion of powdered binder 6 depends on the manufacturing process used and the mechanical properties required for the rigid material 1 to be produced, which may vary according to its different outlets. As the powdered binder 6 is in a different state and much finer than the textile fibers 5, it tends to migrate down the mat 7, falling naturally to the bottom of the mould 8 or onto the continuous conveyor belt of the mat 7. To alleviate this problem, the powdered binder 6 is mixed hot with the textile fibers 5. To do this, the powdered binder 6 is heated to its viscous powder transition temperature, which enables the powdered binder 6 to attach itself permanently to the textile fibers and remain homogeneously dispersed in the mattress 7. Other processes can be used to prevent the powdered binder 6 from migrating to the bottom of the mould 8, for example an electrostatic mixing process or mixing after moistening the textile fibers.

Once this hot mixing has been carried out, the resulting mattress 7 is stable and can be used even a long time after it has been made, without time limits, which is a substantial advantage for production management. The mattress 7 is then placed between a mould 8 and a mould upper part 9 to be heated and pressed simultaneously at a temperature depending on the composition of the powder binder 6 used. For example, with a powder binder 6 consisting of epoxy-polyester powder, the mattress 7 is heat pressed at a temperature of approximately 180° C. for 8 minutes. Pressing is carried out at a high pressure in order to achieve a high density and a smooth, homogeneous surface. This pressure is between 10 kg/cm² and 40 kg/cm², preferably at a pressure of around 30 kg/cm². The thermopressed mat is then kept under cold pressure to control the shape of the rigid material thus obtained during its cooling and thus prevent it from warping or thickening due to the resilience effect. This cooling phase is carried out either by passing through another cold mould of similar shape to the one used for thermopressing, or by cooling the thermopressing mould 8.

The rigid material 1 obtained by this manufacturing process can find a place in many sectors due to its high permissiveness. For example, the rigid material 1 can be used to create panels 2 for manufacturing and furniture as shown in FIG. 1 [FIG. 1]. These panels 2 are intended for manufacturers who want an alternative to conventional particleboard such as mediumboard. Thus, these panels 2 have the same dimensional standards, the same thicknesses, and will have similar or superior mechanical properties to wood fiber-based panels. The second example of the use of rigid material 1 concerns the manufacture of furniture. As shown in FIG. 2 [FIG. 2], rigid panels 1 can be used to manufacture furniture parts directly, such as table tops, chair backs 4 or chair seats 3. In this case, the mould 8 and the upper part of the mould 9 will have shapes suitable for hot-pressing the material 1 into the shapes of the furniture parts to be produced.

In the following, the manufacturing process for rigid material 1 will be described in detail. FIG. 4 [FIG. 4] shows an illustrative diagram of the process for obtaining the textile fibers 5 used to manufacture the rigid material 1. The textile intended for the production of the rigid material 1 comes from a sorting process which may be subcontracted to a professional operator. Garments intended for reuse are separated from the waste collected directly or by the professional operator. The process for preparing textile fibers 10 therefore begins with a stage for sorting reusable garments 10. The garments to be recycled, i.e. those that cannot be reused, are recovered for the manufacture of the rigid material 1.

Next comes the color sorting step 12. The rigid material 1 takes on the color of the textile fibers used, i.e. the garments used to produce at least some of the textile fibers 5 of which it is made. Thus, dyed in the mass, the rigid material 1 acquires a particular aesthetic which increases its added value and when it is used on visible supports, it does not need to be painted.

The color of the panels 2 depends on the textiles chosen. To obtain a given color, all you have to do is sort the used clothing and/or other collected textiles that will be used to manufacture the panels accordingly, so that you can obtain panels in the desired shade. In the standard range of panels 2, textiles will be sorted into 5 colors: cyan, magenta, yellow, black and white. Color sorting of textiles, which is still done manually, represents an additional operation and an additional cost. Nevertheless, automating the color sorting of textiles is easy to implement. For special orders, other colors can be offered. Although color sorting is described mainly in the context of the production of panels 2, it can also be used to produce furniture components 3 and 4 in different colors. Alternatively, it is possible to use textile pieces of neutral color, for example white, which can be dyed to the desired color of the rigid material 1.

After the color sorting stage 12, the textile undergoes an unravelling operation 13 and a defibration operation 14. The unravelling operation consists of dismantling the garments in order to remove hard points such as buttons, rivets, zips, patches . . . .

The defibration operation consists of transforming textile pieces from used clothing or other textile pieces to be recycled into textile fibers 5. Defibration can be carried out by mechanical fraying, thermal grinding or chemical extrusion. However, mechanical unravelling gives the best results for the production of rigid material 1. Unravelling consists of transforming garments or other textile pieces into textile fibers 5 of varying lengths within a sizing range of between 1 and 5 mm, by passing them through an unravelling machine. Shredding is commonly used in the automotive sector for cushion stuffing or as insulation. To complete the preparation of the textile fibers 5, they are passed through a blower stage 15 to loosen and decompact the textile fibers 5. This decompaction will enable the textile fibers 5 to be mixed more homogeneously with the powdered binder 6. The textile fibres 5 are then packed into bales.

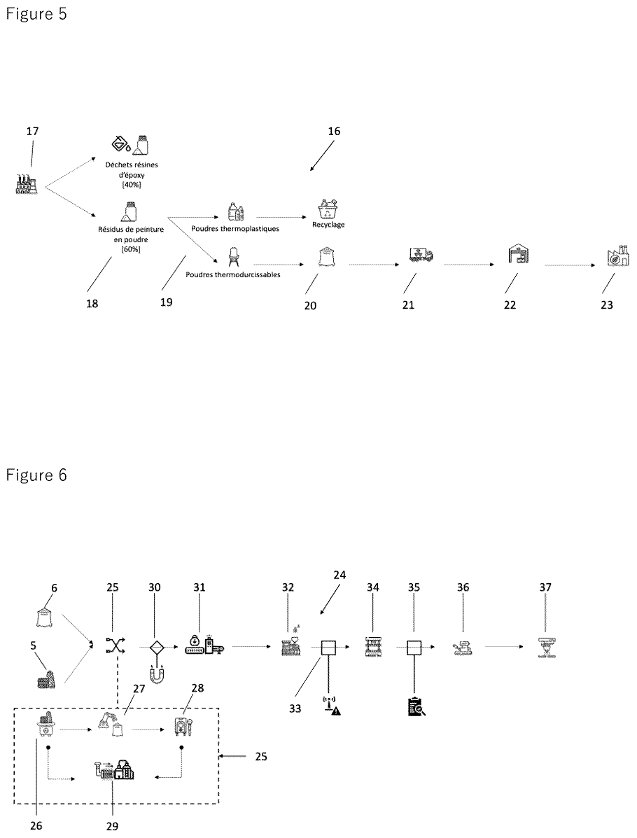

FIG. 5 [FIG. 5] shows an illustrative diagram of the process for obtaining the powder binder 16. As mentioned above, the powder binder 6 used in the manufacture of rigid material 1 is obtained from powder painting waste in industry. The process for obtaining the powder binder 16 begins with a step for collecting the powder paint losses 17 in the industry's paint booths. This is followed by a step to separate the powder paint residues from the epoxy resin waste 18. The powder paints then undergo a sorting operation between thermoplastic powders and thermosetting powders 19. Although thermoplastic powders or thermosetting powders can be used in the manufacture of rigid material 1, thermosetting powders are preferred because they make it possible to obtain a more rigid material with better mechanical properties for making panels for construction or furniture. Unlike thermosetting paint powders, thermoplastic powders can be recycled to make plastic bottles. They therefore already have their own recycling channel. The thermosetting powders used are epoxy-polyester, TGIC, acrylic-urethane or polyester-urethane. The powders collected most often contain a mixture of several of these powders. The thermosetting powders are then stored, for example, in BigBags 20 for transport by ADR-accredited lorry and driver 21 to consolidation companies 22 from which the powder binder 6 is obtained to manufacture the rigid material 1 in production centres 23.

FIG. 6 [FIG. 6] shows a diagram illustrating the manufacturing process for rigid material 24. In the following, the manufacturing process 24 is described for the manufacture of panels 2, but it applies mutatis mutandis to the manufacture of furniture components 3 and 4. The epoxy powders forming the powder binder 6 are mixed with the textile fibers 5 in a proportion by weight of binder of between 20% and 40%. In the described example, the powder binder 6 represents 30% of the total weight, and the textile fibers 5 represent 70% of the total weight. As described above, the powdered binder 6 and the textile fibers 5 are for example mixed hot 25 to avoid the binder sinking to the bottom of the mixture. Other mixing methods for fixing the powdered binder 6 to the textile fibers 5 are possible, for example by wetting the textile fibers 5 or by electrostatic effect. For mixing, the textile fibers are weighed 26, for example using a belt weigher, and the weight of textile fibers 5 determines the weight 27 of powdered binder 6 to be used. The powder binder is brought to its viscous phase temperature 28 to be mixed with the textile fibers 5, for example, by a heated Airlay process 29 or any other pneumatic coating process. After the textile fibers 25 have been sized, they are passed through a magnetic field 30 to remove any metallic residue. This step is preferable but not necessary. They are then evenly distributed on a continuously operating conveyor belt 31. Optionally, the mattress 7 on the conveyor belt is sprayed with additive 32. This spraying step can be carried out before the hot mixing step or on the material after thermopressing. During this stage, one or more additives such as an antifungal agent, a water repellent and/or a flame retardant are applied by spraying. Before the hot-pressing step (34), the mattress 7 is checked using an X-ray weight per unit area balance (33). This stage, prior to pressing, enables the structure of the layers, the humidity and the distribution of the gross density over the thickness of the mattress to be checked for any fluctuations. Foreign bodies with a high raw density (stones, metals, etc.) can again be detected and removed to avoid damaging the presses.

The hot-pressing operation 34 consists of applying a high pressure under heat to modify the density of the mat and transform it into a much denser panel 2. The temperature of the hot press varies between 160° C. and 200° C. depending on the catalysis or polymerisation temperature of the powder binder 6. For a binder based on epoxy powder, the press temperature is preferably 180° C. Thermopressing is carried out for a period of between 6 and 10 minutes, for example 8 minutes, at a pressure of between 10 kg/cm² and 40 kg/cm², for example 20 or 30 kg/cm². For example, thermopressing can be carried out at a temperature of 200° C. for 6 minutes, or at a temperature of 180° C. for 8 minutes, or at 170° C. for 10 minutes.

To save time in the hot-pressing phase, the mat 7 can be pre-pressed to evacuate the air contained in the mat 7. A continuous heated press is used to manufacture panels 2. Cooling under pressure takes place at the outlet of the heated press to prevent the panel from deforming as it cools. At this stage, it is preferable to carry out a quality control of the panel 2. The panel is then calendered (36) to precisely calibrate the desired thickness of the panel and improve the finish of its faces. Calendering 36 can also be used to cool the panel after hot pressing. Alternatively, calendering can be replaced by sanding the surfaces. Sanding can also be carried out in combination with calendering 36. The panel 2 is then cut to the desired dimensions 37.

As indicated in the preceding description, the various aspects of the invention can be implemented according to the context in configuration variants different from those described above. For example, for the production of panels or furniture components.

Naturally, the invention is described in the foregoing by way of example. It is understood that the person skilled in the art will be able to implement different variants of the invention without departing from the scope of the invention.

1. Rigid material for construction or furniture comprising fibrous particles bonded together by a binder belonging to the family of thermoplastic or thermosetting materials such as powdered epoxy resins, characterised in that:
the fibrous particles are textile fibres (5);
the binder (6) is composed of paint powder from unheated paint losses; and
the proportion of binder (6) in the total weight is between 10% and 50%, preferably 20%, 30% or 40%.

2. Rigid material as claimed in claim 1, characterised in that the textile fibers (5) are obtained by fraying textile pieces, at least some of which come from used clothing.

3. Rigid material according to one of claim 1 or 2, in which the textile fibers (5) comprise a mixture of natural and synthetic textile fibers such as cotton or polyester fibers, and/or the rigid material (1) is solution-dyed by the color of the textile fibers (5) used.

4. Rigid material according to one of claims 2 to 4, wherein:
the paint powders (6) used as binders are mainly composed of epoxy, polyester, polyurethane or acrylics; and/or
the paint powders (6) used as a binder comprise paint, primer or varnish powders, or a mixture of these powders.

5. Rigid material according to one of the preceding claims, characterised in that it additionally comprises at least one adjuvant such as an antifungal agent, a water repellent and/or a flame retardant.

6. Rigid material according to one of the preceding claims, characterised in that it is obtained by thermopressing textile fibers (5) and binder (6); and/or its final thickness is obtained by sanding, calendering or cold pressing.

7. A method of manufacturing a rigid material for construction or furniture, characterised in that it comprises the following steps:
a step of collecting paint powders (17) in paint booths to obtain a thermoplastic or thermosetting powder binder (6);
a step (25) of mixing the powdered binder (6) with textile fibers (5) in a proportion of binder of between 20 and 30% of the total weight;
a step (30) of spreading the textile fibers (5) mixed with the binder (6) to form a mat (7); and
a step of hot pressing (32) of said mat (7) at a temperature depending on the nature of the binder (6);
preferably after hot pressing, the material undergoes a cooling step while maintaining pressure.

8. A method of manufacturing a rigid material according to the preceding claim, characterised in that it further comprises the following steps of preparing textile fibers (5):
a color sorting stage (12) for the textile parts to be recycled;
a sorting stage to remove non-fraying textiles;
a smoothing step (13);
a stage of defibration (14) by mechanical fraying of the sorted textile pieces; and/or
a step of separating the textile fibers by blowing (15).

9. Process for manufacturing a rigid material according to one of claims 7 and 8, characterised in that it comprises a step of collecting non-reusable used clothing (11) in order to obtain at least some of the said textile fibers (5), or other pieces of textile to be recycled.

10. A method of manufacturing a rigid material according to one of claims 9 to 10, characterised in that it further comprises the following steps:
a step of spraying (31) with at least one adjuvant; and/or
a calendering (35) and/or sanding step after the hot pressing (32) or cooling step.

11. Method of manufacturing a rigid material according to one of claims 9 to 11, characterised in that it further comprises a step (36) of cutting said rigid material (1) into panels (2) of the required dimensions, or that the hot-pressing step (32) is carried out in a mould to form furniture components (3, 4).

12. A method of manufacturing a rigid material according to one of claims 8 to 12 wherein:
hot pressing (32) is carried out at a temperature of between 160° C. and 200° C., for example 180° C., for a period of between 6 and 10 min, for example 8 min, and/or at a pressure of between 10 kg/cm² and 40 kg/cm², for example 20 or 30 kg/cm²; and/or
the step (25) of mixing the powdered binder (6) with the textile fibers (5) is carried out hot.
